(19) United States
(12) Patent Application Publication
(10) Pub. No.: US 2019/0005346 A1
(43) Pub. Date: Jan. 3, 2019

(54) IMAGE COLLATION METHOD AND IMAGE SEARCH DEVICE

(71) Applicant: FUJITSU LIMITED, Kawasaki-shi (JP)

(72) Inventor: Toshihiro Ozawa, Yokohama (JP)

(73) Assignee: FUJITSU LIMITED, Kawasaki-shi (JP)

(21) Appl. No.: 16/014,377

(22) Filed: Jun. 21, 2018

(30) Foreign Application Priority Data
Jun. 30, 2017 (JP) 2017-128994

(51) Int. Cl. G06K 9/46; G06K 9/32; G06K 9/62

(52) U.S. Cl. CPC G06K 9/46; G06K 2009/6295; G06K 9/6288; G06K 9/3233

(57) ABSTRACT

An image search device includes a processor that calculates a feature quantity of each divided region of a first image. The processor generates integrated regions constituted of adjacent divided regions that have feature quantities having differences within a first range. The processor determines, as first regions, the integrated regions and divided regions not included in the integrated regions. The processor extracts, for each first region, a second region in a second image. The second region has a same shape as a relevant first region and has a feature quantity different from a feature quantity of the relevant first region within a predetermined second range. The processor determines a relationship between a position of a first region in the first image and a position of a second region in the second image. The processor determines whether the first image and the second image have similar portions based on the relationship.

### CROSS-REFERENCE TO RELATED APPLICATION

This application is based upon and claims the benefit of priority of the prior Japanese Patent Application No. 2017-128994, filed on Jun. 30, 2017, the entire contents of which are incorporated herein by reference.

### FIELD

The embodiments discussed herein are related to an image collation method and an image search device.

### BACKGROUND

There is a technique that determines similar portions (partial images) with respect to two images. Such a technique may be used to search for an image including a certain image (e.g., an image showing a specific sign) from among a plurality of images (e.g., images captured by a drive recorder).

For two images (IMAGE-A and IMAGE-B), determination of the presence or absence of similar partial images is performed as follows.

First, each of IMAGE-A and IMAGE-B is divided into local rectangles of a predetermined section (e.g., 48×48 pixels). A local feature quantity (e.g., a binary robust independent elementary feature (BRIEF)) is extracted from a local rectangle including a feature point, among the local rectangles of each of IMAGE-A and IMAGE-B. Hereinafter, each local rectangle of IMAGE-A is referred to as “local rectangle Ra”, and each local rectangle of IMAGE-B is referred to as “local rectangle Rb”. The BRIEF refers to an N bit binary value such that the respective bits thereof are allocated with N pairs (e.g., 128 pairs) of pixels. The N pairs of pixels are randomly determined in a local rectangle in advance. The bit value is “1” when a difference between pixel values (first pixel value−second pixel value) of each pair is a positive value and is “0” when the difference is a negative value.

Subsequently, with respect to each local rectangle Ra including a feature point, a local rectangle Rb is searched for such that a local feature quantity of the local rectangle Rb is at a distance equal to or less than a predetermined threshold value from a local feature quantity of the relevant local rectangle Ra, and a pair of the local rectangle Ra and the local rectangle Rb (corresponding point) is produced. For a local rectangle Ra having a plurality of local rectangles b having a local feature quantity at a distance equal to or less than the predetermined threshold value, a local rectangle Rb having a local feature quantity at the smallest distance is selected. In the case of the BRIEF, a distance between local feature quantities may be defined as the number of different bits because the local feature quantity is a bit stream, and the minimum value thereof is “0” and the maximum value thereof is N.

Subsequently, the existence position (center) of IMAGE-A in IMAGE-B is estimated for each corresponding point. Assuming that IMAGE-A has a width “wa” and a height “ha” and IMAGE-B has a width “wb” and a height “hb”, when the position of the local rectangle Ra of a certain corresponding point in IMAGE-A is (xa, ya) and the position of the local rectangle Rb of the corresponding point in IMAGE-B is (xb, yb), the existence position (xv, yv) of IMAGE-A is obtained by the following calculations:

xv=xb−xa+(wa/2),

yv=yb−ya+(ha/2).

That is, when IMAGE-A is superimposed on IMAGE-B such that the local rectangle Ra of the corresponding point coincides with the local rectangle Rb of the corresponding point (when IMAGE-A is superimposed on IMAGE-B such that patterns thereof match), the position of a center point of IMAGE-A is (xv, yv) in the coordinates of IMAGE-B.

Because the existence position calculated as above is a correct answer for a correct corresponding point, voting is performed on the calculated existence position for each corresponding point, and a final existence position is determined by a majority vote. For example, a predetermined number of votes is casted on a predetermined section (e.g., 4 local rectangle squares) including the calculated existence position for each corresponding point. Thereby, it is possible to perform robust similarity calculation for a certain degree of difference between IMAGE-A and IMAGE-B.

When IMAGE-A and IMAGE-B include similar images, a positional relationship (the size of parallel movement) between IMAGE-A and IMAGE-B at each corresponding point is often consistent, so that votes are concentrated on one place. When IMAGE-A and IMAGE-B include no similar images, a positional relationship between IMAGE-A and IMAGE-B at each corresponding point is inconsistent, so that voted places are dispersed.

Therefore, the maximum value of the number of votes is detected from the space (pixel) that is a vote target, to determine that the portions of the corresponding point, for which voting is performed at the position corresponding to the maximum value, are similar to each other when the maximum value exceeds a predetermined threshold value.

Related techniques are disclosed in, for example, Japanese Laid-Open Patent Publication Nos. 2004-030188 and 2015-118644.

### SUMMARY

According to an aspect of the present invention, provided is an image search device including a memory and a processor coupled the memory. The processor is configured to calculate a feature quantity of each divided region including a feature point, among a plurality of divided regions obtained by dividing a first image. The processor is configured to generate one or more integrated regions constituted of a plurality of adjacent divided regions that have feature quantities having differences within a predetermined first range from each other. The processor is configured to determine, as first regions, the one or more integrated regions and divided regions each including the feature point and not included in any of the integrated regions. The processor is configured to extract, for each of the first regions, a second region in a second image. The second region has a same shape as a relevant first region and has a feature quantity different from a feature quantity of the relevant first region within a predetermined second range. The processor is configured to determine, for each of the first regions, a relationship between a position of a relevant first region in the first image and a position of a second region, which is extracted with respect to the relevant first region, in the second image. The processor is configured to determine whether the first image and the second image have similar portions based on the relationship determined for each of the first regions.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of inappropriate voting;

FIG. 2 is a diagram illustrating an embodiment;

FIG. 3 is a diagram illustrating an exemplary hardware configuration of an image search device according to an embodiment;

FIG. 4 is a diagram illustrating an exemplary functional configuration of an image search device according to an embodiment;

FIG. 5 is a flowchart illustrating an exemplary processing procedure executed by an image search device;

FIG. 6 is a flowchart illustrating an exemplary processing procedure of generating a fusion region;

FIG. 7 is a diagram illustrating an example of a BRIEF;

FIG. 8 is a flowchart illustrating an exemplary processing procedure of voting for a fusion region and a search target image; and

FIG. 9 is a diagram illustrating an example of an existence position of a query image in a search target image, which is calculated based on a target fusion region and a corresponding region thereof.

### DESCRIPTION OF EMBODIMENTS

In a flat image in which variation in local feature quantity is small, the local feature quantities of any local rectangles are similar to each other. As a result, a correct corresponding point may not be identified, which makes proper voting difficult and eventually, makes appropriate similarity determination difficult.

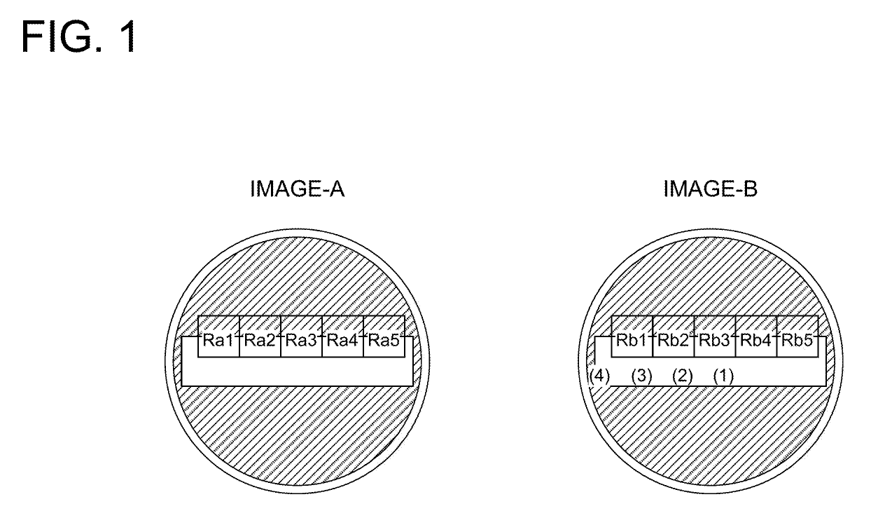

FIG. 1 is a diagram illustrating an example of inappropriate voting. In FIG. 1, local rectangles Ra1 to Ra5 (hereinafter, referred to as “local rectangles Ra” unless distinguished from each other) are illustrated as some of local rectangles of IMAGE-A, and local rectangles Rb1 to Rb5 (hereinafter, referred to as “local rectangles Rb” unless distinguished from each other) are illustrated as some of local rectangles of IMAGE-B.

As is apparent from FIG. 1, each of the respective local rectangles Ra and each of the respective local rectangles Rb have the same distribution of pixel values. Therefore, the local feature quantities of the respective local rectangles are the same. Therefore, when searching for a corresponding point, each local rectangle Rb constitutes the corresponding point with any local rectangle Ra. In such a situation, when a local rectangle Rb relatively positioned on the upper left side is preferentially selected to constitute a corresponding point with a certain local rectangle Ra, all of the corresponding points for the respective local rectangles Ra become the local rectangle Rb1.

Then, the existence position of IMAGE-A based on the corresponding point between the local rectangle Ra1 and the local rectangle Rb1 is the position indicated by (1) on IMAGE-B. The existence position of IMAGE-A based on the corresponding point between the local rectangle Rat and the local rectangle Rb1 is the position indicated by (2) on IMAGE-B. The existence position of IMAGE-A based on the corresponding point between the local rectangle Ra3 and the local rectangle Rb1 is the position indicated by (3) on IMAGE-B. The existence position of IMAGE-A based on the corresponding point between the local rectangle Ra4 and the local rectangle Rb1 is the position indicated by (4) on IMAGE-B.

As described above, when the existence positions are dispersed, even though the region constituted of the respective local rectangles Ra and the region constituted of the respective local rectangles Rb are similar to each other, it is erroneously determined that the two are not similar to each other.

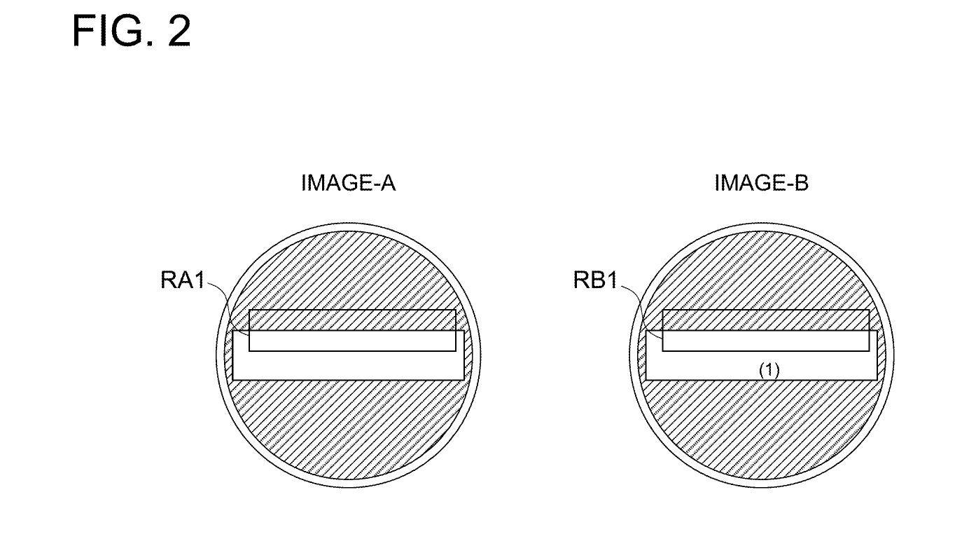

Hereinafter, an embodiment disclosed here will be described below with reference to the drawings. FIG. 2 is a diagram illustrating the embodiment. According to the present embodiment, a plurality of adjacent local rectangles (divided regions) having local feature quantities different from each other within a predetermined range, are fused (integrated). The fusion of the local rectangles is performed recursively. A region constituted of two or more fused local rectangles is hereinafter referred to as a “fusion region”. In IMAGE-A of FIG. 2, a fusion region RA1 is a region in which local rectangles Ra1 to Ra5 of FIG. 1 are fused. In the present embodiment, the feature quantity of the fusion region RA1 is calculated, and a region similar to the fusion region RA1 (hereinafter referred to as a “corresponding region”) is searched for from IMAGE-B. As a result, in IMAGE-B, a corresponding region RB1 constitutes a corresponding point with the fusion region RA1. At the existence position (1) of IMAGE-A in IMAGE-B, which is identified based on the aforementioned corresponding point, the number of votes, which corresponds to the number of local rectangles included in the fusion region RA1, is casted. That is, five times the number of votes for a corresponding point between single local rectangles is casted. As a result, there is a high possibility that the number of votes at the existence position (1) exceeds a predetermined threshold value, and thus, there is a high possibility that IMAGE-A and IMAGE-B are determined as including similar partial images.

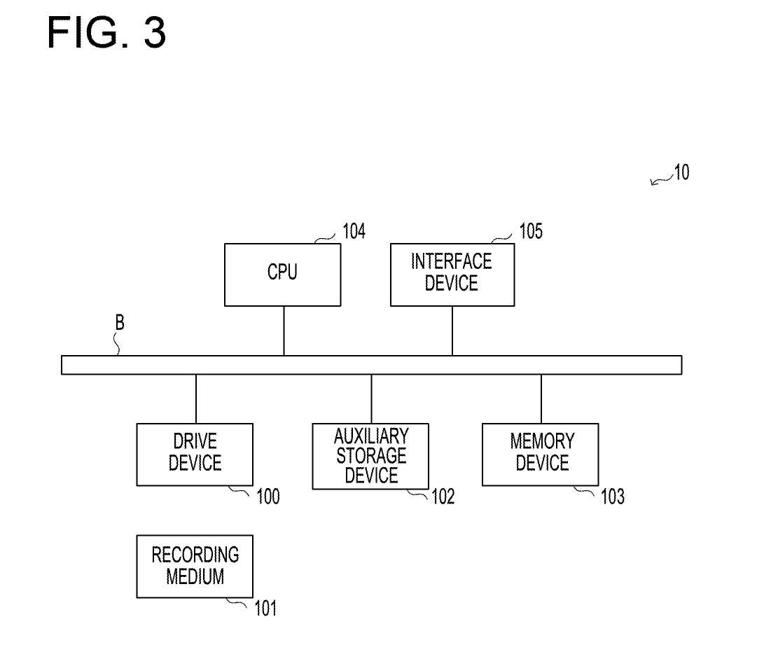

An image search device 10 that executes such a process will be specifically described. FIG. 3 is a diagram illustrating an exemplary hardware configuration of the image search device 10 according to the present embodiment. The image search device 10 of FIG. 3 includes, for example, a drive device 100, an auxiliary storage device 102, a memory device 103, a central processing device (CPU) 104, and an interface device 105, which are mutually coupled via a bus B.

A program is provided by a recording medium 101 to realize a process in the image search device 10. When the recording medium 101, having stored therein the program, is set in the drive device 100, the program is installed from the recording medium 101 to the auxiliary storage device 102 via the drive device 100. However, it may not be necessary to install the program from the recording medium 101, but it may be possible to download the program from another computer via a network. The auxiliary storage device 102 stores the installed program, and also stores required files or data, for example.

When an instruction to activate the program is issued, the program is read from the auxiliary storage device 102 and stored in the memory device 103. The CPU 104 executes a function of the image search device 10 based on the program stored in the memory device 103. The interface device 105 is used as an interface for connecting to a network.

An example of the recording medium 101 may be a portable recording medium, such as a compact disc read-only memory (CD-ROM), a digital versatile disc (DVD), or a universal serial bus (USB) memory. An example of the auxiliary storage device 102 may be a hard disk drive (HDD) or a flash memory. Each of the recording medium 101 and the auxiliary storage device 102 corresponds to a computer-readable recording medium.

The image search device 10 may be constituted of a plurality of computers having the configuration illustrated in FIG. 3.

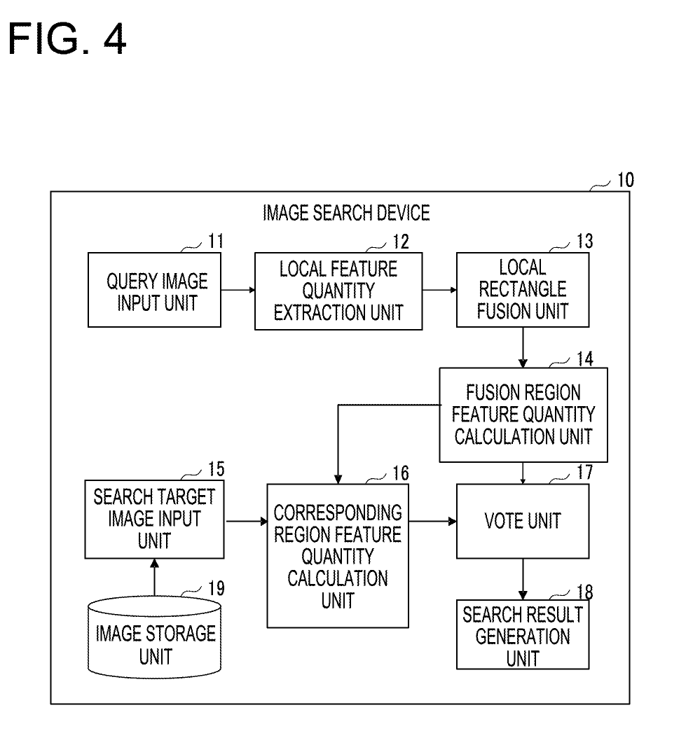

FIG. 4 is a diagram illustrating an exemplary functional configuration of the image search device 10 according to the embodiment. In FIG. 4, the image search device 10 includes, for example, a query image input unit 11, a local feature quantity extraction unit 12, a local rectangle fusion unit 13, a fusion region feature quantity calculation unit 14, a search target image input unit 15, a corresponding region feature quantity calculation unit 16, a vote unit 17, and a search result generation unit 18. The image search device 10 also includes an image storage unit 19. The image storage unit 19 may be realized using, for example, the auxiliary storage device 102 or a storage device that is connectable to the interface device 105 via a network.

The query image input unit 11 inputs a query image. The query image refers to image data as a search key, that is, a partial image (similar image) similar to a partial image of the query image is searched for. The query image may be received via a network. An image, which is specified by a user at a terminal, for example, may be received as the query image by the query image input unit 11.

The local feature quantity extraction unit 12 extracts a local feature quantity from a local rectangle including a feature point among a plurality of local rectangles obtained by dividing the query image. In the present embodiment, a binary robust independent elementary feature (BRIEF) is used as the local feature quantity. However, any other known feature quantity, such as an oriented FAST and Rotated BRIEF (ORB), may be used.

The local rectangle fusion unit 13 generates a fusion region based on the local feature quantity extracted from each local rectangle of the query image. Specifically, the local rectangle fusion unit 13 generates a fusion region by recursively fusing adjacent local rectangles that have local feature quantities having differences (variations) equal to or less than a predetermined threshold value γ from each other. When a local rectangle has a local feature quantity having differences more than the predetermined threshold value γ from all local feature quantities of adjacent local rectangles, the local rectangle constitutes a fusion region by itself.

The fusion region feature quantity calculation unit 14 calculates the feature quantity of each fusion region.

The search target image input unit 15 inputs a search target image. The search target image refers to image data that is subject to a collation with the query image (a target for determination of the presence or absence of a similar image). For example, a plurality of pieces of image data stored in the image storage unit 19 may be sequentially input as the search target image.

The corresponding region feature quantity calculation unit 16 searches the search target image for candidates of a corresponding region (hereinafter referred to as a “corresponding region candidates”) with respect to each fusion region in the query image, and calculates feature quantities of the detected corresponding region candidates to identify the corresponding region.

The vote unit 17 identifies, for each fusion region, a relationship between a position of the fusion region in the query image and a position of the corresponding region of the fusion region in the search target image. The vote unit 17 votes on the existence position (center position) of the query image in the search target image based on the relationship between the position of the fusion region in the query image and the position of the corresponding region of the fusion region in the search target image.

The search result generation unit 18 determines whether the query image and the search target image have similar partial images based on the vote result by the vote unit 17, and generates information indicating the determined result as a search result.

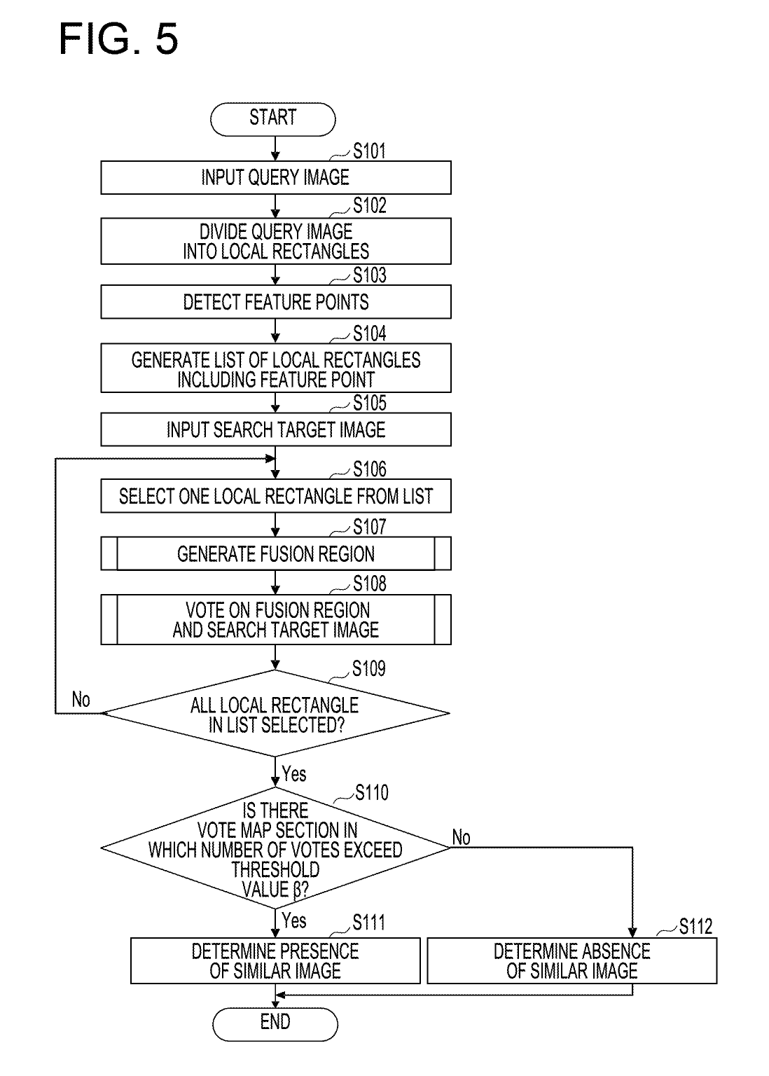

Hereinafter, a processing procedure executed by the image search device 10 will be described. FIG. 5 is a flowchart illustrating an exemplary processing procedure executed by the image search device 10.

When the query image input unit 11 inputs, for example, a received query image (S101), the local feature quantity extraction unit 12 divides the query image into a plurality of local rectangles of a predetermined section (e.g., 48×48 pixels) (S102). Subsequently, the local feature quantity extraction unit 12 detects feature points of the query image (S103). Detection of the feature points may be performed based on known techniques. Subsequently, the local feature quantity extraction unit 12 identifies local rectangles including a feature point, and generates a list of the identified local rectangles (hereinafter referred to as a “rectangle list”) (S104). Subsequently, the search target image input unit 15 inputs, for example, one search target image from the image storage unit 19 (S105).

Subsequently, the local feature quantity extraction unit 12 selects one local rectangle in the rectangle list as a processing target (S106). Hereinafter, the selected local rectangle is referred to as a “target local rectangle”. Subsequently, the local feature quantity extraction unit 12 and the local rectangle fusion unit 13 execute a process of generating a fusion region based on the target local rectangle (S107). The fusion region based on the target local rectangle refers to a region obtained by recursively searching for a local rectangle that is adjacent to the target local rectangle and has a local feature quantity having a difference equal to or less than the predetermined threshold value γ from the local feature quantity of the target local rectangle. When there is no local rectangle that has a local feature quantity having a difference equal to or less than the predetermined threshold value γ, among the local rectangles adjacent to the target local rectangle, the target local rectangle is determined to be a fusion region by itself.

Subsequently, for each of all corresponding regions having the same shape as the fusion region, in the search target image, the vote unit 17 votes on the existence position (center position) of the query image in the search target image based on the fusion region and the corresponding region thereof (S108). For a single existence position, a predetermined number of votes are performed on a predetermined range of section (e.g., four local rectangles) including the existence position. This section is referred to as “vote map section”.

When steps S106 to S108 are executed for all of the local rectangles in the rectangle list (Yes in S109), the search result generation unit 18 determines the presence or absence of a vote map section in which the number of votes exceeds a predetermined threshold value β (S110). When there exists a vote map section in which the number of votes exceeds the predetermined threshold value β (Yes in S110), the search result generation unit 18 determines that the query image and the search target image have similar images, and outputs information indicating the determined result (S111). The range of similar images may be output based on the corresponding region, which triggers the vote to the vote map section.

When there exists no vote map section in which the number of votes exceeds the predetermined threshold value β (No in S110), the search result generation unit 18 determines that there exists no similar image in the search target image, and outputs information indicating the determined result (S112).

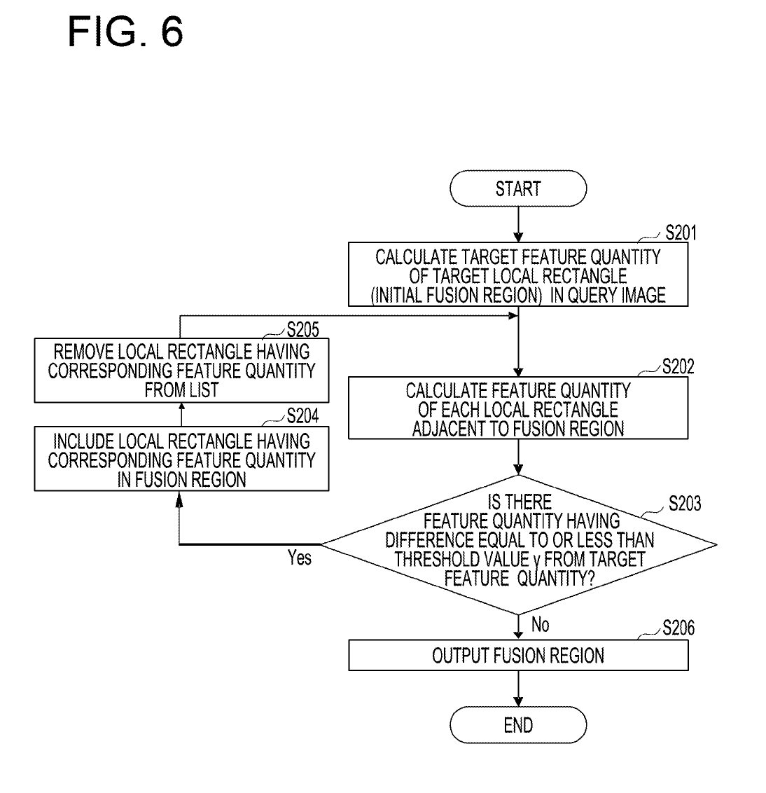

Subsequently, details of step S107 will be described. FIG. 6 is a flowchart illustrating an exemplary processing procedure of generating a fusion region.

In step S201, the local feature quantity extraction unit 12 sets the target local rectangle as a fusion region in an initial state. The local feature quantity extraction unit 12 calculates a local feature quantity of the fusion region (i.e., the target local rectangle). For example, BRIEF is calculated as the local feature quantity. Hereinafter, the local feature quantity of the target local rectangle is referred to as a “target feature quantity”.

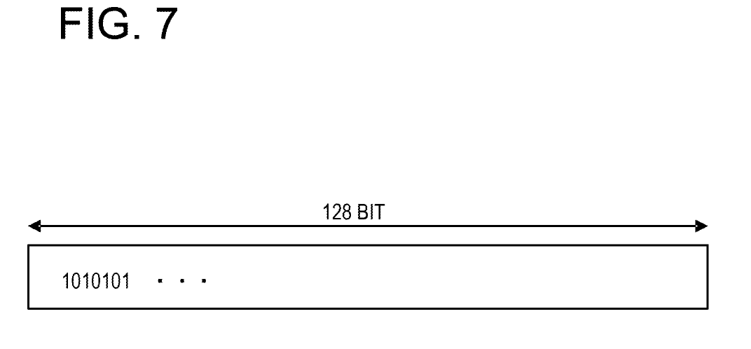

FIG. 7 is a diagram illustrating an example of the BRIEF. As illustrated in FIG. 7, the BRIEF is an N bit binary value, which is “1” when a difference between pixel values (e.g., first pixel value−second pixel value) of each pair, among N pairs of pixels (e.g., N is 128) randomly determined in advance in a local rectangle, is a positive value, and which is “0” when the difference is a negative value.

Subsequently, the local feature quantity extraction unit 12 calculates a local feature quantity for each local rectangle that is adjacent to the fusion region (hereinafter referred to as “target fusion region”) in either of upward, downward, leftward, and rightward directions (S202).

Subsequently, the local rectangle fusion unit 13 determines the presence or absence of local feature quantities having a difference equal to or less than the predetermined threshold value γ from the target feature quantity, among the calculated local feature quantities (S203). When there are one or more local feature quantities having a difference equal to or less than the predetermined threshold value γ from the target feature quantity (Yes in S203), the local rectangle fusion unit 13 includes the local rectangles having the local feature quantities to the target fusion region (S204). As a result, the target fusion region expands. Subsequently, the local rectangle fusion unit 13 removes the local rectangles included in the target fusion region from the rectangle list (S205). Therefore, the local rectangles are excluded from a selection target in step S106 of FIG. 5. Subsequently, step S202 is repeated.

When there is no local feature quantity having a difference equal to or less than the predetermined threshold value γ from the target feature quantity (No in S203), the local rectangle fusion unit 13 outputs the target fusion region at this point in time (S206). The target fusion region is not necessarily limited to a rectangle.

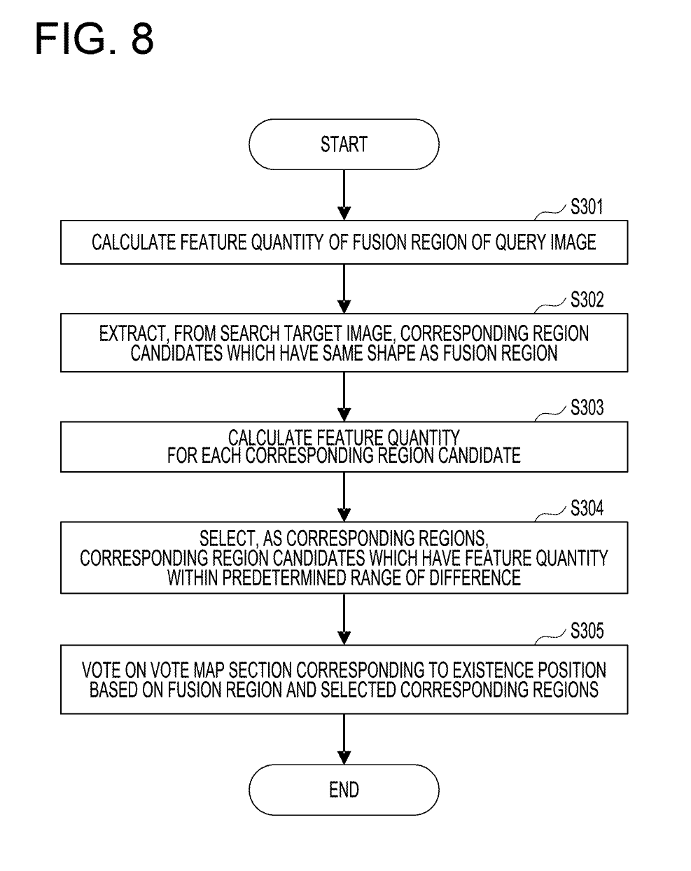

Subsequently, details of step S108 in FIG. 5 will be described. FIG. 8 is a flowchart illustrating an exemplary processing procedure of voting for a fusion region and a search target image.

In step S301, the fusion region feature quantity calculation unit 14 calculates a feature quantity of a target fusion region generated in a query image.

The feature quantity of the fusion region has the same number of bits as the local feature quantity. The value of each bit of the feature quantity of the fusion region is determined, for example, by a majority vote for each bit of the local feature quantity of the respective local rectangles constituting the fusion region. That is, a bit of the feature quantity of the fusion region is “1” when the number of “1” is greater than the number of “0” in the corresponding bit of the local feature quantities of the respective local rectangles constituting the fusion region, and is “0” when the number of “0” is greater than the number of “1”. For example, it is assumed that three local rectangles x, y and z are fused and the local feature quantities of the respective local rectangles are as follows, respectively:

Local rectangle x: “1100 . . . ”;

Local rectangle y: “1000 . . . ”; and

Local rectangle z: “1110 . . . ”.

In this case, the feature quantity of the fusion region is “1100 . . . ”. The value of the bit having the same majority vote may be, for example, “1”.

Subsequently, the corresponding region feature quantity calculation unit 16 divides a search target image into local rectangles having the same size as the local rectangles of the query image, and extracts corresponding region candidates, which have the same shape as the target fusion region, from the search target image (S302). When there are a plurality of corresponding region candidates, all of the corresponding region candidates are extracted.

Subsequently, the corresponding region feature quantity calculation unit 16 calculates a feature quantity for each of the extracted corresponding region candidates (S303). For example, the corresponding region feature quantity calculation unit 16 calculates a Hamming distance between feature quantities of local rectangles included in a corresponding region candidate. The corresponding region feature quantity calculation unit 16 sets all bits of the feature quantity of the corresponding region candidate to “1” when the corresponding region candidate includes local rectangles having local feature quantities such that the Hamming distance therebetween is equal to or greater than y. By doing so, the corresponding region candidate is not selected as a corresponding region. When the corresponding region candidate does not include local rectangles having local feature quantities such that the Hamming distance therebetween is equal to or greater than y, the corresponding region feature quantity calculation unit 16 calculates the feature quantity of the corresponding region candidate in the same way as calculating the feature quantity of the fusion region.

Subsequently, the vote unit 17 selects, as corresponding regions, corresponding region candidates having feature quantities within predetermined range of difference from the feature quantity of the target fusion region (S304). For example, a corresponding region candidate may be selected as a corresponding region, if the Hamming distance between the feature quantity of the corresponding region candidate and the feature quantity of the target fusion region is equal to or less than a predetermined threshold value α. For example, as illustrated in FIG. 2, in a case where IMAGE-A is the query image and IMAGE-B is the search target image, when the fusion region RA1 is the target fusion region, the corresponding region RB1 is extracted. The Hamming distance is the number of different bits.

Subsequently, the vote unit 17 votes, for each selected corresponding region, on the vote map section including the existence position of the query image in the search target image. The existence position is calculated based on the target fusion region and the corresponding region (S305). At this time, a weight depending on the size of the target fusion region (the number of local rectangles included in the target fusion region) is given to the value to be voted. For example, when the target fusion region includes five local rectangles, 5 votes are casted to the vote map section. That is, a larger weight is given a fusion region including a larger number of local rectangles.

The existence position of the query image in the search target image calculated based on the target fusion region and the corresponding region refers to a position of the center of the query image in the search target image when the query image and the search target image are superimposed so that the target fusion region and the corresponding region coincide with each other.

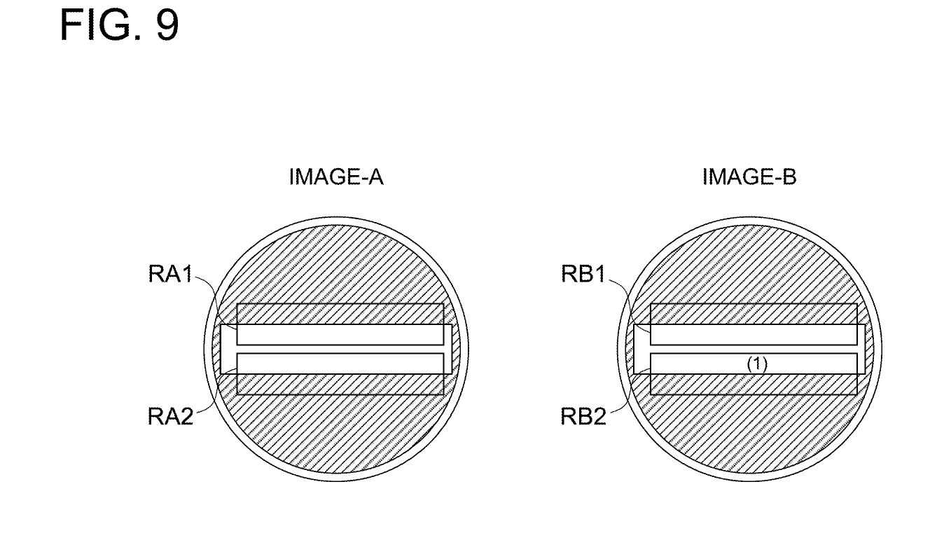

FIG. 9 is a diagram illustrating an example of an existence position of a query image in a search target image, which is calculated based on a target fusion region and a corresponding region thereof. In FIG. 9, the existence position of IMAGE-A in IMAGE-B, which is calculated based on the fusion region RA1 and the corresponding region RB1, is the position indicated by (1). Because the fusion region RA1 includes five local rectangles, five times the vote value for one local rectangle is casted on (1). The existence position of IMAGE-A in IMAGE-B, which is calculated based on a fusion region RA2 and a corresponding region RB2, is also the position indicated by (1). Because the fusion region RA2 includes five local rectangles, five times the vote value for one local rectangle is further casted to (1). As a result, there is a high possibility that the vote value on (1) exceeds the predetermined threshold value β, and thus, there is a high possibility that IMAGE-A and IMAGE-B are determined as including similar partial images.

As described above, according to the present embodiment, in a case where local rectangles having local feature quantities different from each other within a predetermined range are successive, the presence or absence of similar portions in a pair of image data to be collated is determined based on a fusion region in which the local rectangles are fused (integrated). As a result, it is possible to detect similar partial images even between flat images in which variation in local feature quantity between the local rectangles is small. That is, it is possible to improve the accuracy of determination of similarity between an image, in which variation in the feature quantity of each divided region is small, and another image.

In the present embodiment, the query image is an example of a first image. The search target image is an example of a second image. The local rectangle is an example of a divided region. The fusion region is an example of a first region. The corresponding region is an example of a second region. The predetermined threshold value γ is an example of a first range. The predetermined threshold value α is an example of a second range. The image search device 10 is an example of an image search device. The local feature quantity extraction unit 12 is an example of an extraction unit. The local rectangle fusion unit 13 is an example of a first identification unit. The corresponding region feature quantity calculation unit 16 is an example of a second identification unit. The vote unit 17 is an example of a third identification unit. The search result generation unit 18 is an example of a determination unit.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
calculating a feature quantity of each divided region including a feature point, among a plurality of divided regions obtained by dividing a first image;
generating one or more integrated regions constituted of a plurality of adjacent divided regions that have feature quantities having differences within a predetermined first range from each other;
determining, as first regions, the one or more integrated regions and divided regions each including the feature point and not included in any of the integrated regions;
extracting, for each of the first regions, a second region in a second image, the second region having a same shape as a relevant first region and having a feature quantity different from a feature quantity of the relevant first region within a predetermined second range;
determining, for each of the first regions, a relationship between a position of a relevant first region in the first image and a position of a second region, which is extracted with respect to the relevant first region, in the second image; and
determining whether the first image and the second image have similar portions based on the relationship determined for each of the first regions.

2. The non-transitory computer-readable recording medium according to claim 1, the process further comprising:
determining the relationship while giving a larger weight for a first region including a larger number of divided regions.

3. An image collation method, comprising:
calculating, by a computer, a feature quantity of each divided region including a feature point, among a plurality of divided regions obtained by dividing a first image;
generating one or more integrated regions constituted of a plurality of adjacent divided regions that have feature quantities having differences within a predetermined first range from each other;
determining, as first regions, the one or more integrated regions and divided regions each including the feature point and not included in any of the integrated regions;
extracting, for each of the first regions, a second region in a second image, the second region having a same shape as a relevant first region and having a feature quantity different from a feature quantity of the relevant first region within a predetermined second range;
determining, for each of the first regions, a relationship between a position of a relevant first region in the first image and a position of a second region, which is extracted with respect to the relevant first region, in the second image; and
determining whether the first image and the second image have similar portions based on the relationship determined for each of the first regions.

4. The image collation method according to claim 3, further comprising:
determining the relationship while giving a larger weight for a first region including a larger number of divided regions.

5. An image search device, comprising:
a memory; and
a processor coupled the memory and the processor configured to:
calculate a feature quantity of each divided region including a feature point, among a plurality of divided regions obtained by dividing a first image;
generate one or more integrated regions constituted of a plurality of adjacent divided regions that have feature quantities having differences within a predetermined first range from each other;
determine, as first regions, the one or more integrated regions and divided regions each including the feature point and not included in any of the integrated regions;
extract, for each of the first regions, a second region in a second image, the second region having a same shape as a relevant first region and having a feature quantity different from a feature quantity of the relevant first region within a predetermined second range;
determine, for each of the first regions, a relationship between a position of a relevant first region in the first image and a position of a second region, which is extracted with respect to the relevant first region, in the second image; and
determine whether the first image and the second image have similar portions based on the relationship determined for each of the first regions.

6. The image search device according to claim 5, wherein
The processor is configured to:
determine the relationship while giving a larger weight for a first region including a larger number of divided regions.
